(19) United States
(12) Patent Application Publication
(10) Pub. No.: US 2013/0287368 A1
(43) Pub. Date: Oct. 31, 2013

(54) METHOD AND APPARATUS FOR PERSONAL/DIGITAL VIDEO RECORDER (PVR/DVR) PERMANENT ERASE

(71) Applicants: Chad Andrew Lefevre, Indianapolis, IN (US); Martin Vincent Davey, Indianapolis, IN (US)

(72) Inventors: Chad Andrew Lefevre, Indianapolis, IN (US); Martin Vincent Davey, Indianapolis, IN (US)

(21) Appl. No.: 13/978,992

(22) PCT Filed: Jan. 18, 2011
(86) PCT No.: PCT/US11/00089

§ 371 Date: Jul. 10, 2013

(51) Int. Cl. H04N 9/79

(52) U.S. Cl. CPC H04N 9/79
USPC 386/248

(57) ABSTRACT

The present application provides the user with an option to permanently erase an episode in a series recording, or a non-series recording of media content from their PVR/DVR storage. After watching recorded content on a PVR/DVR, the user is provided with an option to “permanently delete” the particular media content. In the example of a series recording, the user is provided with the ability to prevent their PVR/DVR from recording an already watched episode in a series recording and thereby saving valuable storage space on the PVR/DVR.

### BACKGROUND

1. Technical Field

The present principles relate to personal video recording (PVR) and digital video recording (DVR) devices. More particularly, it relates to a method and apparatus for permanently erasing recorded information from the PVR/DVR storage device.

2. Related Art

A personal video recorder (PVR) or digital video recorder (DVR) is a device that allows the user to selectively record various programming content provided by the service provider. PVR/DVRs can be stand alone devices, or more commonly, are integrated into the set top box provided by the service provider (e.g., cable or satellite dish television providers).

On the PVR/DVR, the user is typically provided with the ability to record an episode of a program such that the same episode will not be recorded again while that episode is still on the hard drive of the PVR/DVR. However, if the user deletes a particular episode after watching the same, the particular episode can be recorded again by the PVR/DVR if it is re-run. This is particularly the case when the user sets their PVR/DVR to record an entire series of a particular program.

One option in an attempt to resolve this known problem is to set the PVR/DVR to record “first run” episodes only (i.e., new episodes). However, if the user is recording an episode and wants to watch older episodes of that same program that the PVR/DVR did not record because they are not “new episodes”, this option becomes obsolete.

### SUMMARY

According to an embodiment, the user can provide the PVR/DVR with an instruction to never record a particular episode again.

This and other aspects are achieved in accordance with an embodiment of the invention, wherein the method for permanent erase on a personal or digital video recorder (PVR/DVR) includes determining whether received guide information includes media content that is part of a scheduled recording, identifying whether the media content has been previously flagged for permanent deletion by a user when the received guide information includes media content that is part of the scheduled recording, and marking the identified media content as matching schedule but not being recorded due to previous flag for permanent deletion.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles can be better understood in accordance with the following exemplary figures, in which:

FIG. 1 is flow diagram of the method for PVR permanent erase according to an embodiment of the invention; and

FIG. 2 is a block diagram of a set top box which can implement the method of the present invention.

### DETAILED DESCRIPTION

The present invention is directed to personal or digital video recorders (PVRs or DVRs), either stand alone or those integrated into set top boxes (STBs).

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

In accordance with one embodiment, the present invention enables a user to set their PVR/DVR to permanently erase an episode in a series recording.

The concept of the present invention is herein described by way of the following example. A user likes the show No Reservations on the Travel Channel and starts watching it a year or two after it first aired. They frequently re-run episodes during the week from the current and previous seasons. The user sets up a series recording on their PVR. The PVR quickly collects (records) about twenty episodes. After watching each episode the user deletes it from their PVR so it doesn't run out of recording space. Unfortunately, since episodes are frequently re-run, the PVR will keep recording the same episodes (i.e., the same as those previously recorded, watched and deleted) in addition to episodes that have not been seen by the user. Thus, the user's prior deletion of a viewed episode does not result in a “permanent” deletion of the same, since the PVR does not refer to a user's prior deletion when recording an episode in a series.

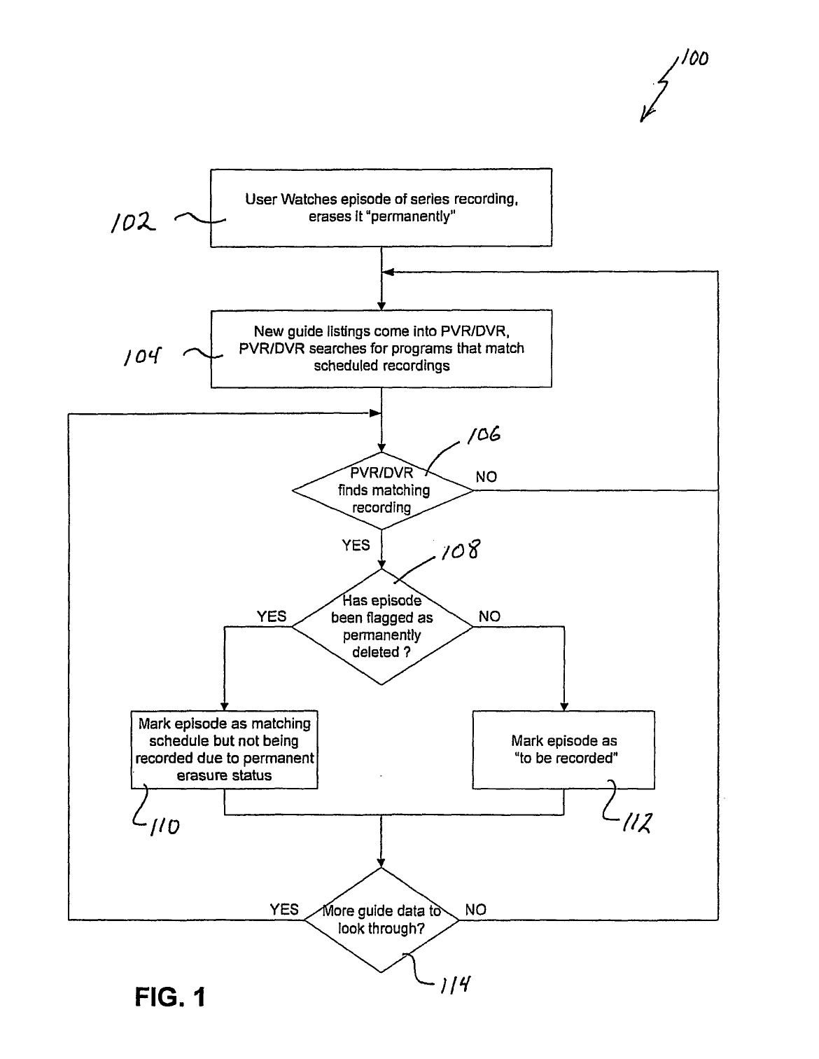

The present invention provides the user with an option to permanently erase an episode in a series recording, and also in non-series recording of media content. As will be described with reference to FIG. 1 below, by allowing the PVR/DVR user to flag a recording as “permanent”, the PVR/DVR can be informed before recording that a particular recording need not be made.

Referring to FIG. 1 there is shown the method 100 for permanently deleting content from a PVR/DVR. Initially, a user watches an episode that has been part of a “series” recording and decides to erase it permanently (step 102). By deciding to erase the episode permanently, when the user enters the PVR/DVR menu to delete the program, they are provided with another delete option which can be, for example, “delete permanently”. By selecting this option, the PVR/DVR creates a file (or database) of episodes to be deleted permanently. Thus, the selected episode for permanent deletion is now flagged in the PVR/DVR database/memory. As new guide listings come into the PVR/DVR, the PVR/DVR searches for programs that match the scheduled recordings (step 104). Next the PVR/DVR determines whether there is a matching recording corresponding to the scheduled recordings (step 106). If not, the system returns to step 104 and awaits new guide listings. If there is a match at step 106, a subsequent determination as to whether or not this matching episode has been flagged as “permanently deleted” (step 108).

If the identified episode has been flagged to be permanently deleted, the episode is marked as matching but is not recorded (step 110) as a result of the permanent delete flag. If the identified episode has not been flagged to be permanently deleted, the episode is marked as “to be recorded” (step 112) and the process proceeds to step 114 where a determination as to whether there is more guide data to be reviewed. If yes, the process returns to step 106. If not, the process returns to step 104 and awaits new guide listing data.

Thus, as can be seen from the above, the user can selectively identify any one or more episodes in a series type recording where the PVR/DVR knows in advance not to record the same based on the user's prior flagging of an already watched and deleted episode. Although described in the context of a series recording, the above principles can also be applied to non-series like programming. For example, the user can simply decide to prevent their PVR/DVR from recording a particular movie or program after the user watches the same. In this manner, the PVR/DVR would not allow a user to subsequently record the particular movie or program without removing the same from the “permanently delete” database.

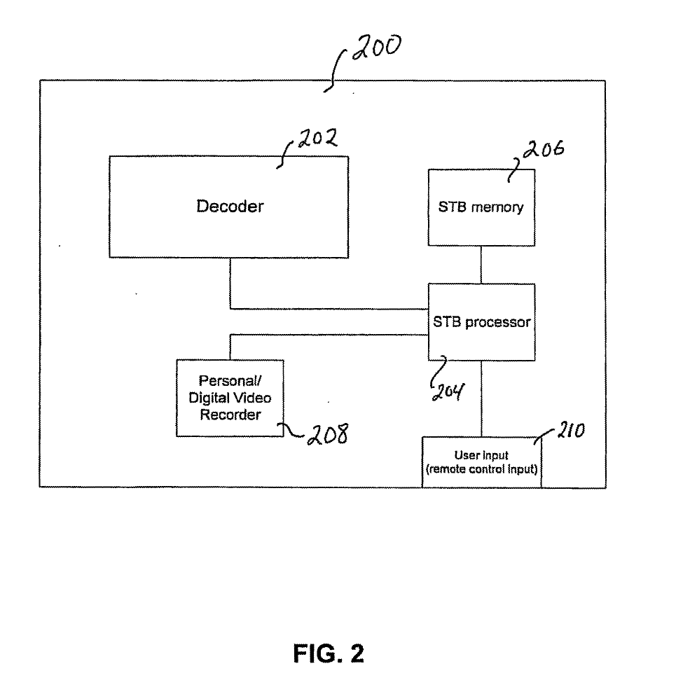

Referring to FIG. 2, there is shown a set top box (STB) 200 into which the present invention can be implemented. By way of example, the STB 200 includes a decoder 202 in signal communication with an external input (now shown) for receiving and decoding the video/audio content, in addition to guide information from a service provider (e.g., cable or satellite provider). Those of skill in the art will appreciate that the decoder 202 generally contains all the circuitry and processing capability necessary for the decoding functions. The STB 200 also includes an STB processor 204 in signal communication with the decoder 202 and a persona/digital video recorder (PVR/DVR). In addition the STB processor 204 can include an associated memory 206. In this example, although the PVR/DVR 208 is shown in this example as part of the STB 200, those of skill in the art will appreciate that the PVR/DVR 208 can be a standalone device which can incorporate the method for permanent erase of the present invention. In this example, the user controls the PVR/DVR 208 through the user input 210 which is generally a remote control device used to navigate through menus and various other graphical user interfaces (GUIs). In this manner, the user can navigate to the PVR/DVR menus to set up series recordings and also manage the permanent erase functions of the invention by a GUI that enables the user to select such option when deleting content recorded in the PVR/DVR 208.

These and other features and advantages of the present principles can be readily ascertained by one of ordinary skill in the pertinent art based on the teachings herein. It is to be understood that the teachings of the present principles can be implemented in various forms of hardware, software, firmware, special purpose processors, or combinations thereof.

Most preferably, the teachings of the present principles are implemented as a combination of hardware and software. Moreover, the software can be implemented as an application program tangibly embodied on a program storage unit. The application program can be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform can also include an operating system and microinstruction code. The various processes and functions described herein can be either part of the microinstruction code or part of the application program, or any combination thereof, which can be executed by a CPU. In addition, various other peripheral units can be connected to the computer platform such as an additional data storage unit and a printing unit.

It is to be further understood that, because some of the constituent system components and methods depicted in the accompanying drawings are preferably implemented in software, the actual connections between the system components or the process function blocks can differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications can be effected therein by one of ordinary skill in the pertinent art without departing from the scope or spirit of the present principles. All such changes and modifications are intended to be included within the scope of the present principles as set forth in the appended claims.

1. A method for permanent erase on a personal or digital video recorder (PVR/DVR) comprising the steps of:
determining whether received guide information includes media content that is part of a scheduled recording;
identifying whether the media content has been previously flagged for permanent deletion by a user when the received guide information includes media content that is part of the scheduled recording; and
marking the identified media content as matching schedule but not being recorded due to previous flag for permanent deletion.

2. The method of claim 1, wherein prior to said determining step the method further comprises:
flagging the media content for permanent deletion by a user; and
receiving new guide listings into the PVR/DVR.

3. The method of claim 1, further comprising marking the media content to be recorded when said identifying steps results in no flag for permanent deletion being identified.

4. The method of claim 1, further comprising determining whether more guide data is required to be searched after said marking step.

5. The method of claim 1, wherein the scheduled recording comprises a series recording, wherein the previously flagged media content comprises at least on episode in the series recording.

6. An apparatus for enabling permanent erase on a personal or digital video recorder (PVR/DVR), the apparatus comprising:
means for determining whether received guide information includes media content that is part of a scheduled recording;
means for identifying whether the media content has been previously flagged for permanent deletion by a user when the received guide information includes media content that is part of the scheduled recording; and
means for marking the identified media content as matching schedule but not being recorded due to previous flag for permanent deletion.

7. The apparatus of claim 6, further comprising:
means for flagging the media content for permanent deletion by a user; and
means for receiving new guide listings into the PVR/DVR.

8. The apparatus of claim 6, further comprising means for marking the media content to be recorded when said means for identifying steps results in no flag for permanent deletion being identified.

9. The apparatus of claim 6, further comprising means for determining whether more guide data is required to be searched after said marking step.

10. The apparatus of claim 6, wherein the scheduled recording comprises a series recording, and wherein the previously flagged media content comprises at least on episode in the series recording.

11. A processor readable medium having stored thereon instructions for causing a processor to perform at least the following:
determining whether received guide information includes media content that is part of a scheduled recording;
identifying whether the media content has been previously flagged for permanent deletion by a user when the received guide information includes media content that is part of the scheduled recording; and
marking the identified media content as matching schedule but not being recorded due to previous flag for permanent deletion.

12. The processor readable medium of claim 11, further comprising instructions stored thereon for causing the processor to further perform:
flagging the media content for permanent deletion by receiving a user input; and
receiving new guide listings into the PVR/DVR.

13. The processor readable medium of claim 11, further comprising instructions stored thereon for causing the processor to further perform marking the media content to be recorded when said identifying results in no flag for permanent deletion being identified.

14. The processor readable medium of claim 11, further comprising instructions stored thereon for causing the processor to further perform determining whether more guide data is required to be searched after said marking.

15. An apparatus comprising:
a decoder configured to receive and decode signals from a service provider comprising media content and guide information;
a digital video recorder configured to record media content;
a memory configured to store data;
a user input configured to receive inputs from a user; and
a processor configured to determine whether received guide information includes media content that is part of a scheduled recording, identify whether the media content has been previously flagged for permanent deletion by a user when the received guide information includes media content that is part of the scheduled recording, and mark the identified media content as matching schedule but not being recorded due to previous flag for permanent deletion.

16. The apparatus of claim 15, wherein the processor is further configured to mark the media content to be recorded when no flag for permanent deletion being identified.

17. The apparatus of claim 15, wherein the scheduled recording comprises a series recording, and wherein the previously flagged media content comprises at least on episode in the series recording.
